(19) United States
(12) Patent Application Publication
(10) Pub. No.: US 2015/0187460 A1
(43) Pub. Date: Jul. 2, 2015

(54) Wire and Cable Management Device

(71) Applicant: Robert L. DeLoache, Watkinsville, GA (US)

(72) Inventor: Robert L. DeLoache, Watkinsville, GA (US)

(21) Appl. No.: 14/140,926

(22) Filed: Dec. 26, 2013

(51) Int. Cl. H01B 7/00

(52) U.S. Cl. CPC H01B 7/0045

(57) ABSTRACT

A wire and cable management device is disclosed which facilitates the organization of multiple electrical instruments. The device comprises two connected shell-like halves that clamp onto the wire and cables which are oriented and separated within the device. Apertures in opposing sides of the device are aligned to permit easy orientation and identification of the cords as they enter and exit the device. The device optionally includes adhesive strips which can be used to adhere the device to a fixed surface (table, desk, etc.) to further assist in the orderly placement of wires and cables passing through the device.

### BACKGROUND OF INVENTION

Desktop computers typically share that desktop with multiple peripherals such as a screen, keyboard, backup memory, separate speakers, etc. Each is typically interconnected with wires and/or cable arranged in random patterns. This produces clutter and confusion as one sorts through a random array of wires to find the appropriate one to disconnect or reconnect. This random, spaghetti-like sprawl of wires is also unsightly and can lead to connection or disconnection of an inappropriate wire.

Various approaches to cable/wire management have been pursued by others. For example, U.S. Pat. No. 8,121,304 describes various devices for organizing multiple branches of headphone cords in a way that reduces the chances of their becoming tangled.

U.S. Published Patent Application No. 2013/0305495 published Nov. 21, 2013 discloses a cord management device wherein flexible wiring, that might otherwise get tangled, is inserted in one or more rigid U-shaped members which hold the wiring in a manner that prevents tangling.

U.S. Published Patent Application No. 2013/0115804 assigned to Quirky Inc. discloses a cord management apparatus in which wires are wrapped around spools to minimize tangling.

Wire and cable used to connect electrical apparatus presents a difficult organizational challenge because of varying thicknesses, flexibility and lengths. Thus, some of the approaches in the patents and applications discussed above have limited use with specific types of cords.

There is therefore a need for a cord management device that is useable with a wide variety of cord thicknesses, shapes and flexibility.

### SUMMARY OF THE INVENTION

This invention has equal application to the organization of most wires and cables. It is particularly suited to management of wire and cable used to provide electrical connection among, and communication between, electrical apparatus and peripherals. Each and all of such wires and cables will be collectively referred to herein as “cords.”

This organization of cords is accomplished using the disclosed clam shell device. The halves of the subject clam shell can be opened to allow alignment of cords therein. One or more resilient inserts are placed within the clam shell to hold the cords in place within the shell after it is shut. The device can be secured to a surface convenient to the electrical apparatus connected by the cords thereby maintaining an orderly alignment of same.

### BRIEF DESCRIPTION OF THE DRAWINGS

FIG. 1 is a perspective view of the wire and cable management device of this invention showing the placement of cords and resilient insert within the device before closure of the device.

FIG. 2 is another perspective view of the device when closed with the cords secured within the device.

FIG. 3 illustrates the device with cords secured therein and placed on the side of a desk.

FIG. 4 is a perspective view of the device in its open position without the resilient inserts in place.

FIG. 5 is a bottom plan view of the device showing adhesive strips on one part thereof that can be used to attach the device to a fixed surface.

FIG. 6 is a cross-sectioned view along lines 6-6 of FIG. 5 without the resilient inserts in place illustrating one form of hinge and latch useable with the device.

### DETAILED DESCRIPTION OF THE INVENTION

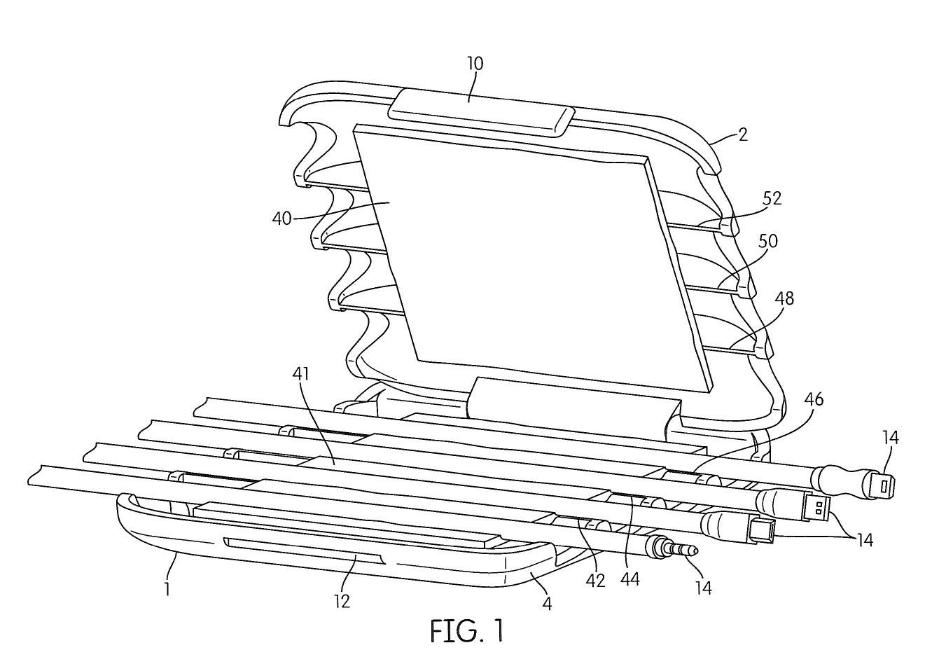

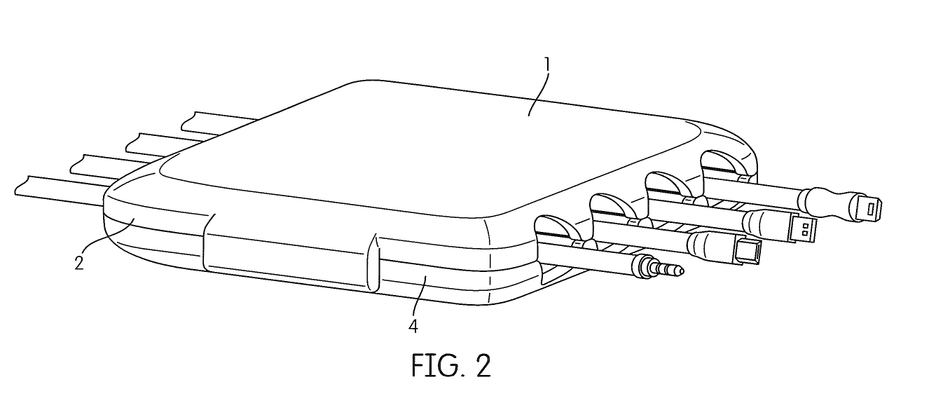

The subject wire and cable management device 1 includes a clamshell superstructure comprising two complementary half shells 2 and 4 joined at one side by a hinge 6 (See FIG. 6). Depending upon the weight of cords being managed, the hinge can range in strength and durability from a “living hinge” molded into one edge of half shells 2 and 4 or a mechanical hinge as shown in FIG. 6. Opposite the hinge is a snap latch 8 where an overhanging bar 10 extending along the edge of shell 2 snaps over a corresponding depression 12 in shell 4 (See FIG. 1) to hold the half shells together. Otherwise, any of numerous latch or hinge mechanisms can be used.

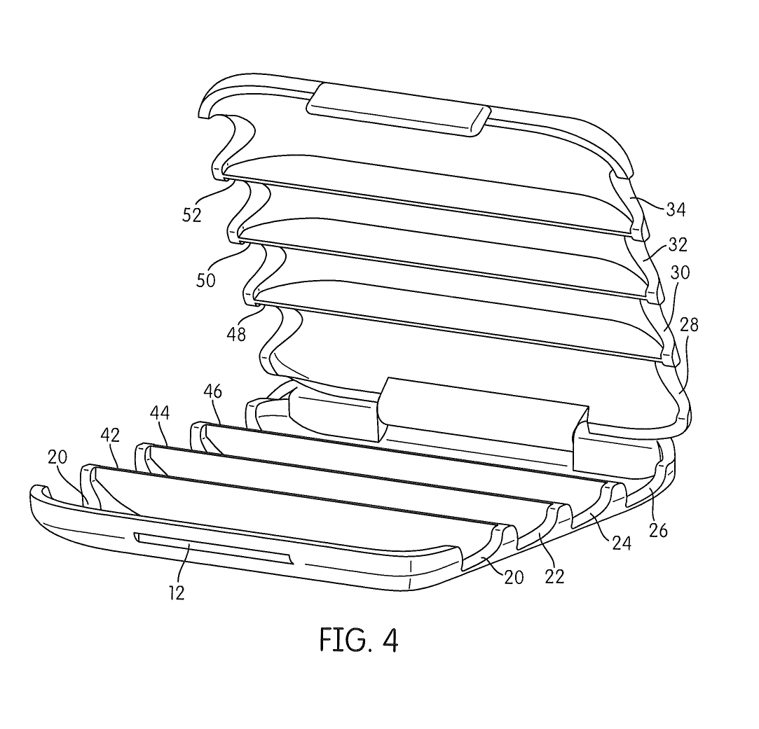

The mating half shells 2 and 4 of device 1 preferably have multiple recesses 20-34 on opposing edges thereof as illustrated in FIG. 4. The recesses can be of an appropriate shape and size to accommodate the cross sections of the most commonly used cords 14. It has been found that semicircular recesses work best to accommodate the various size cords likely to be used.

The half shells 2 and 4 are preferably formed by injection molding. A preferred composition of the shell halves 2 and 4 is a thermoplastic polymer such as high density polystyrene or high density acrylonitrile butadiene styrene (ABS).

One or more resilient inserts 40, 41 are preferably placed within at least one half shell 2 or 4 to surround and grip the cords 14 (See FIG. 1). A preferred insert material is a closed cell medium density polyurethane with a density of about 1-3 pounds per cubic foot. Other similar insert materials may be used, particularly expanded polyolefins. The inserts 40, 41 are selected to have sufficient rigidity that they create friction with the cords in place when the shells 2 and 4 are closed yet allow the cords to be adjusted longitudinally relative to the device 1 as needed, for example, to connect a cord to an operating device. In a preferred embodiment a single resilient 40 insert is used to maintain the cords in place, although in certain applications both inserts 40 and 41 may be used.

The inserts 40, 41 are dimensioned to fit flat in the half shells 2 and 4 in the area above and/or below the cords 14 as shown in FIG. 1.

In a preferred embodiment the resilient inserts 40 and 41 are about ¼ to ½ inch thick, and cover about 70 to 80% of the area of the shell interior. These parameters provide the proper friction that holds the cords in place when the shells 20 and 4 are closed yet allow some movement of the cords within the device 1. This invention also contemplates an embodiment where the resilient material 40, 41 is formed within the shell.

Once in place within the device the portions of the cords extending beyond the device 1 are readily identifiable (See FIG. 1) thereby facilitating their attachment to the correct peripheral equipment.

As illustrated in FIGS. 1 and 4, the interior of shells 2 and 4 may also be molded with physical dividers 42-52 to further separate and maintain alignment of the cords within the device. And as noted above the resilient material may be molded in place around and/or above the dividers.

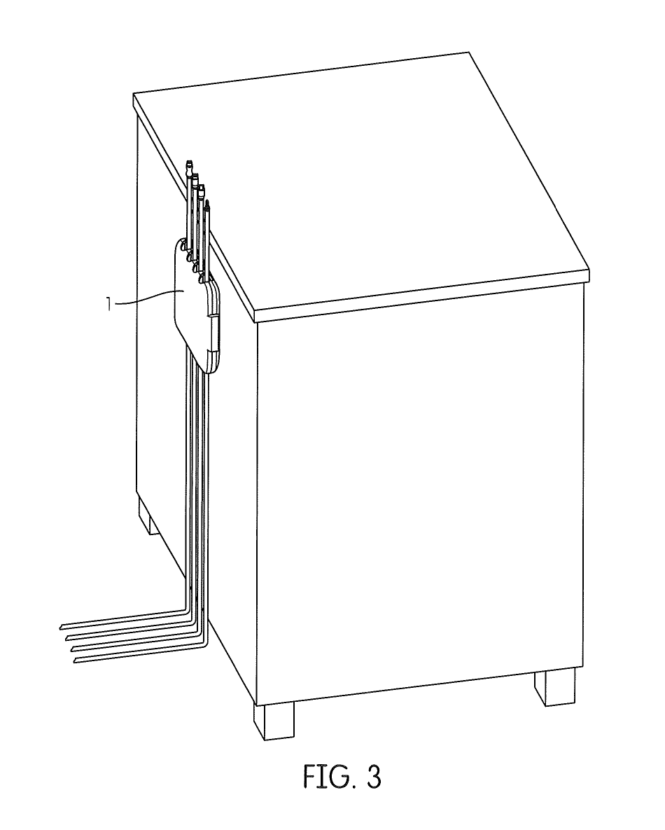

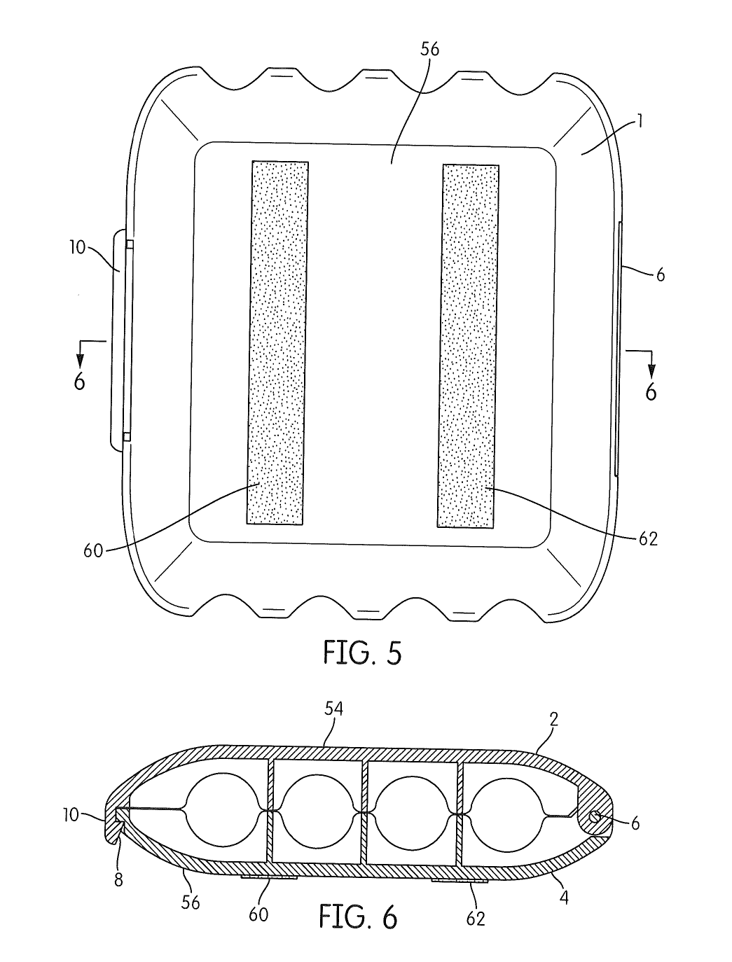

In a preferred embodiment of the invention, adhesive strips 60, 62 are added to one or both of the outer flat surfaces 54 and 56 of shells 2 and 4, respectively (See FIGS. 5-6). The adhesive surface of the strips may be covered with a peel off outer layer (not shown) until the wire and cable device is located at a desired position on a desk or table (See FIG. 3) at which time the outer layer is peeled off to expose the adhesive surface of the strips 60, 62 and the device 1 is pressed into place. Once the device is anchored it is possible to adjust the cords within the wire and cable management device 1 so that their ends are proximate to the devices to which they are to be connected. This feature assists in promoting the orderly alignment of cords and avoidance of clutter and confusion typically found adjacent electronic and electrical components.

I claim:

1. A wire and cable management device comprising
mating, generally rectangular, shells having complementary edges and a recessed interior;
a hinge interconnecting at least one portion of the edges of the shells;
a latch mechanism adjacent another portion of the edge of the shells opposite the hinge for securely connecting the shells;
and multiple complementary recesses formed in opposite edges of at least one shell sized to maintain separation of wires or cables in position within the device.

2. The wire and cable management device of claim 1 wherein at least one of the recessed interiors of the mating shells is partially filled with a resilient material that exerts a compressive force on wires or cables placed in the device to maintain the wires and cables in place within the mating shells.

3. The wire and cable device of claim 2 wherein the resilient material is a closed cell, medium density polyurethane.

4. The wire and cable device of claim 1 wherein at least a portion of the outer surface of the shell is planar.

5. The wire and cable device of claim 4 wherein the planar surface includes adhesive strips capable of securing the wire and cable device to a surface.
